(19) United States
(12) Patent Application Publication
(10) Pub. No.: US 2012/0020689 A1
(43) Pub. Date: Jan. 26, 2012

(54) PRINTING SYSTEM INCLUDING PRINTING APPARATUSES

(76) Inventors: Takahiro INOUE, Ibaraki (JP); Masahiro Mizuno, Ibaraki (JP)

(21) Appl. No.: 13/185,740

(22) Filed: Jul. 19, 2011

(30) Foreign Application Priority Data
Jul. 26, 2010 (JP) 2010-167176
Jun. 28, 2011 (JP) 2011-142854

(51) Int. Cl. G03G 15/20

(52) U.S. Cl. 399/68

(57) ABSTRACT

A printing system having a first printing apparatus to form an image on one side of continuous recording medium roll, a second printing apparatus arranged downstream from the first printing apparatus to form an image on the other side of the recording medium, and a controller to control conveyance of the recording medium. The second printing apparatus has a control device that identifies the number of pages of the recording medium placed on a path between the first printing apparatus and the second printing apparatus and a storage device to store a value representing a contraction amount of the recording medium thermally contracted by excessive heating in a heat fixing device of the first printing apparatus according to a condition defining the contraction amount to align positions of images formed on both sides of the recording medium.

### BACKGROUND OF THE INVENTION

1. Field of the invention

The present invention relates to a printing system formed of at least two printing devices employing electrophotography, etc.

2. Description of the Background

As a printing system to form images on both sides of a continuous recording medium (hereinafter referred to as web) such as a roll of paper, for example, a system having two printing apparatuses arranged in tandem is in actual use. The first printing apparatus prints an image on a first side (surface) of a web and the web is discharged from the first printing apparatus. Thereafter, the web is reversed by a reversing device and sent to the second printing apparatus where another image is printed on the other (second) side of the web.

The printing apparatus may be configured to print images and texts based on printing data per unit of area of a predetermined length (hereinafter referred to as a page), with the pages then separated by severing after printing. In an image forming apparatus employing electrophotography, the image bearing member (drum) is irradiated and scanned by a laser beam in a predetermined cycle according to the printing data to be printed on the web. Subsequently, the pattern on the image bearing member (drum) is visualized by toner to obtain a visible toner image. The toner image is then transferred at a transfer unit to the web, which is conveyed at a constant speed. The web to which the pattern has been transferred is heated to fix the pattern thereon to complete the printing.

Currently, printing systems that can print images on webs with and webs without feed holes are dominant. However, printing images on the web without feed holes without image misalignment on both sides is difficult in some cases. For example, in the case of an electrophotographic printing apparatus, heat is applied to a toner image transferred onto the web in the thermal fixing process, which may cause the web to contract. Consequently, if multiple printing apparatuses are arranged in a single printing system, the web contracted in the thermal fixing process of the first printing apparatus is sent to the second printing apparatus. That is, the length of the unit area (page) is different on the front side and the reverse side. Therefore, the images foamed on the front side and the reverse side may be misaligned.

To solve this problem, for example, Japanese patent application publication no. 2002-187660 (JP-2002-187660-A) describes a duplex printing system that aligns the image positions of the front side and the reverse side by forming an alignment mark at a predetermined position of a web at the first printing apparatus and phase-matching the timing of a web transfer control signal generated per predetermined cycle and a the timing of a (detection signal of the alignment mark at the second printing apparatus. In addition, JP-2005-096081-A describes a duplex printing system that aligns the image positions by changing the transfer speed of an excessively heated unit area of the web and forming an image on the unit area transferred at an altered speed.

However, in the printing system of JP-2005-096081-A, since the web transfer speed is corrected only by the difference between the detection timing of the alignment mark and the predetermined timing for alignment of images on the front side and the reverse side, misalignment control may be incomplete in some cases. In particular, the image on an excessively thermally-contracted page becomes shrunk relative to the transfer (conveyance) direction in comparison with the image on the reverse side. To be specific, the measuring timing of the alignment mark formed on a page next to the page having a severely thermally-contracted part is significantly earlier than that of the previous page. Therefore, the web transfer speed is required to be reduced significantly to align the image positions on the front and reverse sides.

In addition, when printing operation is suspended due to trouble, etc., in the printing system, the web is continuously heated by a fixing preliminarily heating plate and a heating roll of the printing apparatus during the suspension. In that case, the web may be thermally-contracted and transformed more severely than with heat contraction caused in the normal fixing process. Thus, a printing system that can control image positioning on both sides of a web even when the web is severely thermally contracted during suspension of the printing apparatus is sought but has not been provided yet.

### SUMMARY OF THE INVENTION

In view of the foregoing, the present invention provides an improved printing system including a first printing apparatus to form an image on a first side of a continuous recording medium roll having sectionable pages of predetermined length in the direction of conveyance of the recording medium and no feed holes therein, the first printing apparatus having a heat fixing device including a heating roll and a device to form an alignment mark on the pages, a second printing apparatus provided downstream from the first printing apparatus to form an image on a second side of the recording medium roll and including a detector to detect the alignment mark and a control device to measure one of a gap between the alignment marks detected by the detector and a detection timing and control a conveyance speed of the recording medium roll according to measurement results, the control device including a device that identifies the number of pages of the recording medium placed on the transfer path between the first printing apparatus and the second printing apparatus and a storage device to store a value representing a contraction amount by which the recording medium is thermally contracted by excessive heating by the heat fixing device of the first printing apparatus correlated with a condition defining the contraction amount, and aligns positions of images foamed on both sides of the recording medium according to the contraction amount, and a controller including a CPU and associated memory devices to control conveyance of the recording medium.

It is preferred that, in the printing system described above, the storage device of the control device of the second printing apparatus stores a value representing a contraction amount of a leading page relative to the conveyance direction of the recording medium.

It is still further preferred that, in the printing system described above, the condition defining the contraction amount is a retention time of the recording medium in the heat fixing device of the first printing apparatus due to suspension of conveyance thereof.

It is still further preferred that, in the printing system described above, the condition defining the contraction amount is a preset temperature of the heating roll of the heat fixing device of the first printing apparatus.

It is still further preferred that, in the printing system described above, the condition defining the contraction amount is a length of the sectionable pages of the recording medium heated by the heat fixing device of the first printing apparatus.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a diagram illustrating an example of the printing system forming the printing system of the present disclosure;

FIG. 2 is a schematic diagram illustrating an example of the entire structure of the printing system of the present disclosure;

FIG. 3 is a schematic diagram illustrating positional relationships of alignment marks on a web;

FIG. 4 is a diagram illustrating alignment control in the printing system of the present disclosure;

FIG. 5 is a timing chart for use in typical alignment control;

FIG. 6 is a timing chart illustrating synchronous control of a web transfer and an image bearing member (photoreceptor drum);

FIG. 7 is a diagram illustrating misalignment of image positions on a page A₁ having a thermally contracted part and the reverse page A₂ thereof;

FIG. 8 is a diagram illustrating a corrected state of misalignment of images on a page A₁ having a thermally contracted part and the reverse page A₂ thereof;

FIG. 9 is a diagram illustrating a method of determining the page A₁ having a thermally contracted part;

FIG. 10 is a block chart of a control device 200 of a printing apparatus P2;

FIG. 11 is an enlarged diagram illustrating the main part of the thermal fixing device;

FIG. 12 is a graph illustrating the relationship between the contraction amount Δx, the termination time Tz, and the set temperature H of the heating roll;

FIG. 13 is a graph illustrating the relationship between the contraction amount Δx, the termination time Tz, and the ratio S of L5 to the page length;

FIG. 14 is a diagram illustrating another method of determining the page A₁ having a thermally contracted part; and

FIG. 15 is a diagram illustrating a state in which misalignment of the image position of the page A₁ having a thermally contracted part is corrected.

### DETAILED DESCRIPTION OF THE INVENTION

The printing system is described with reference to accompanying drawings.

The printing system of the present disclosure includes a first printing apparatus that forms an image on the first (front) side of a continuous recording medium roll (long band form) in the direction of conveyance of the recording medium (hereinafter referred to as web) without a feed hole, a second printing apparatus that is arranged downstream from the first printing apparatus and forms an image on the second (reverse) side of the web, and a controller that controls transfer of the web.

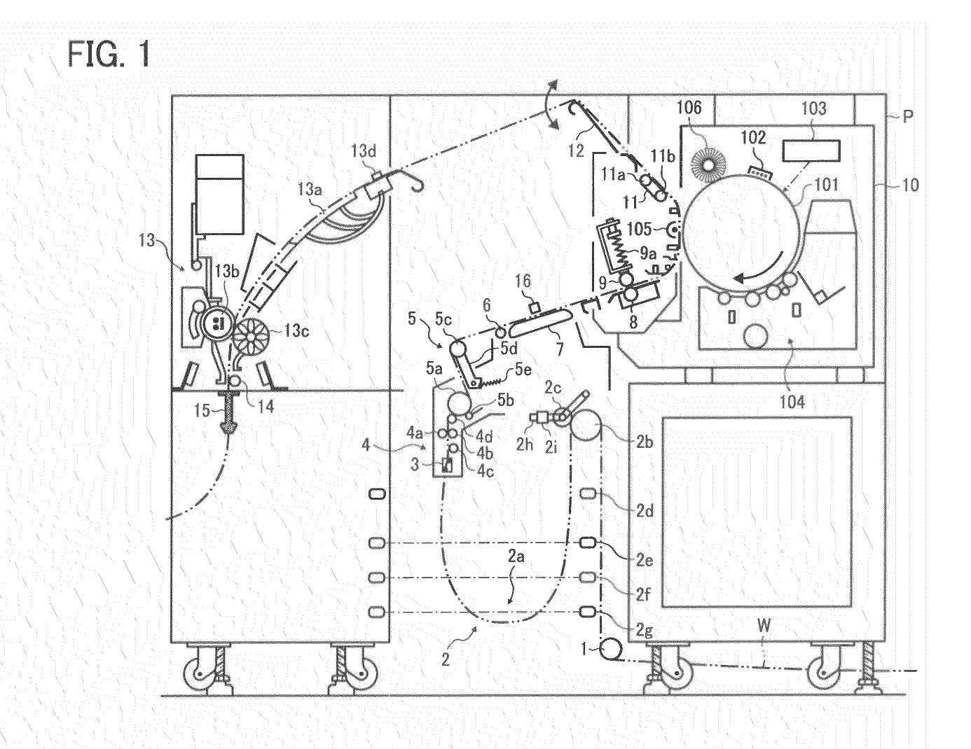

FIG. 1 is a diagram illustrating an example of the electrophotographic image forming apparatus as one of the embodiments of the printing apparatus which is used in the printing system of the present disclosure.

As illustrated in FIG. 1, a web W is fed from a paper feeder into the inside of a printing apparatus P and guided to a web buffer mechanism 2 by a guiding roller 1. Any web such as paper and plastic film on which images can be formed by a printing apparatus forming the printing system of the present disclosure can be suitably used. Paper is commonly used.

The web buffer mechanism 2 includes a temporary storage 2a that temporarily stores the web W to be transferred, multiple optical sensors 2d, 2e, 2f, and 2g that detect the buffer (loose) amount of the web W, and a pair of rollers 2b and 2c provided on the upstream side relative to the web transfer (conveyance) direction. The roller 2c includes an adjustment mechanism that adjusts the contact pressure to the roller 2b. In this embodiment, a weight 2i is slidably provided to an axis 2h protruding from an end of the roller 2c so that the contact pressure of the roller 2c to 2b is adjusted by changing the position of the weight 2i. The web buffer mechanism 2 in this embodiment may have the same structure as that in the printing system described in JP-2002-187660-A.

The web W that has passed through a guiding member 3 is fed into a foreign object removing mechanism 4. The foreign object removing mechanism 4 includes fixed shafts 4a, 4b, 4c, and 4d. The shafts 4a and 4b are provided with a predetermined extremely small gap therebetween to prevent enter of foreign objects.

The web W is then transferred to a tension applying mechanism 5. The tension applying mechanism 5 is formed of a drum 5a having no driving force, a roller 5b provided in contact with the drum 5a with a pressure, and a drum 5c movably supported in the web transfer path. The drum 5a is fixed at a free end of an arm 5d rotary supported and urged against the surface of the web W by a spring 5e. The tension of the web W is maintained to be constant by the tension applying mechanism 5.

Furthermore, the web W is transferred to a printing unit 10 by transfer rollers 8 and 9 via a guide shaft 6 and a guide board 7. In this embodiment illustrated in FIG. 1, a printing apparatus employing elecctrophotography is used as the printing unit 10 but the present disclosure is not limited thereto. For example, a printing device employing an ink jet system can be used.

When a photoreceptor drum 101 illustrated as an example of the image bearing starts rotation, a high voltage is applied to a corona charger 102 and the surface of the photoreceptor drum 101 is, for example, positively charged uniformly. The photoreceptor drum 101 is irradiated with a light beam emitted from a light source 103 formed of a semiconductor, a luminous diode, etc. according to image data to form a latent electrostatic image on the photoreceptor drum 101. When the photoreceptor drum area that holds the latent electrostatic image reaches the position facing a development device 104, a development agent is supplied to the latent electrostatic image to form a toner image on the photoreceptor drum 101.

The toner image formed on the photoreceptor drum 101 is attracted to the web W by function of a transfer device 105 that imparts charges having a reversed polarity to that of the toner image to the back of the web W. The area that has passed through the transfer position of the photoreceptor drum 101 is cleaned by a cleaner 106 and prepared for the next printing operation.

The web W to which the toner image has been transferred from the printing unit 10 as described above is transferred by a transfer belt 11 furthermore. The transfer roller 8 is provided as a driving roller having a driving force and driven by a motor described later. The transfer roller 9 is provided as a driven roller pressed against the transfer roller 8 via the web W by the elastic force of a spring 9a. In addition, the transfer belt 11 is suspended over a driving roller 11a and a driven roller 11b and has an attraction device to transfer the web while the back of the web W is adsorbed on the transfer belt 11.

The web W sent out from the transfer belt 11 is transferred to a heat fixing device 13 via a buffer plate 12. The web that has reached the heat fixing device 13 is preliminary heated by a pre-heater 13a and transferred while being heated and pressed at a nipping portion formed by a pair of fixing rollers of a heating roll 13b and a pressing roll 13c so as to melt and fix the toner image.

The web W that has been sent out by the heating roll 13b and the pressing roll 13c is alternately folded and distributed by a swing of a swing fin 15 via a sending-out roller 14 and piled in the printing apparatus P.

By contrast, in the printing system having another (second) printing apparatus provided at the back of the first printing apparatus P, the web W that has been sent out by the heating roll 13b and the pressing roll 13c is discharged outside the printing apparatus P via the sending-out roller 14 as illustrated in two-dot chain line in FIG. 1 and transferred toward the second printing apparatus. A sensor 13d is provided to detect meandering of the web W.

In the printing system of the present disclosure, the first printing apparatus has a device to form an alignment mark corresponding to the unit area separated (sectionable) by a predetermined length in the transfer direction of the continuous recording medium roll and the second printing apparatus provided at the back of the first printing apparatus has a detector to detect the alignment mark and a control device that measures one of the distance between the alignment marks detected by the detector and the detection timing and controls the transfer speed of the continuous recording medium roll according to the measuring result. In FIG. 1, a sensor 16 is a mark sensor provided to the second printing apparatus as the detector that detects the alignment mark.

When an image is formed on the surface of the web W by the first printing apparatus, for example, the alignment mark is printed at the leading end (top) of the page as the unit area separated by the predetermined length which is to be severed after printing. The second printing apparatus provided at the back detects the alignment mark by the mark sensor 16.

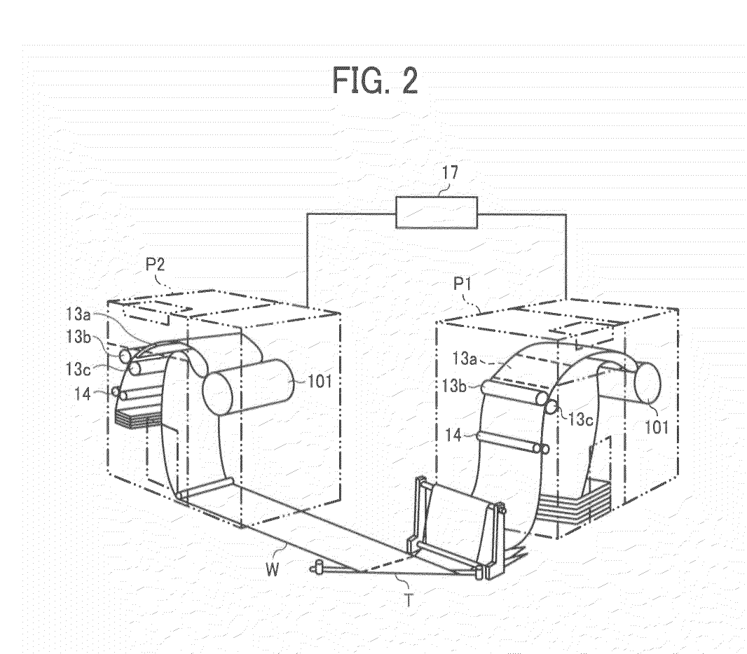

FIG. 2 is a schematic diagram illustrating one embodiment of the entire structure of the printing system of the present disclosure.

As illustrated in FIG. 2, the printing system of the present disclosure is formed of the printing apparatuses P1 and P2 having the structure illustrated in FIG. 1 and a controller 17 connected with the two printing apparatuses.

The web W that was sent out from the first printing apparatus P1 after an image was formed on the first side of the web W is reversed by the reversing device T and then fed into the second printing apparatus P2 where another image is formed on the second side of the web W.

When the second printing apparatus P2 forms an image on the reverse side of the first surface where another image is already formed by the first printing apparatus P1, the controller 17 that controls the image data of P1 and P2 normally monitors the number of pages existing between the first printing apparatus P1 and the second printing apparatus P2. The controller 17 has a CPU and associated memory devices to control conveyance of the recording medium. The controller 17 outputs to the second printing apparatus P2 the number of pages of the web W existing between a transfer point TP of the first printing apparatus P1 and a transfer point TP of the second printing apparatus P2.

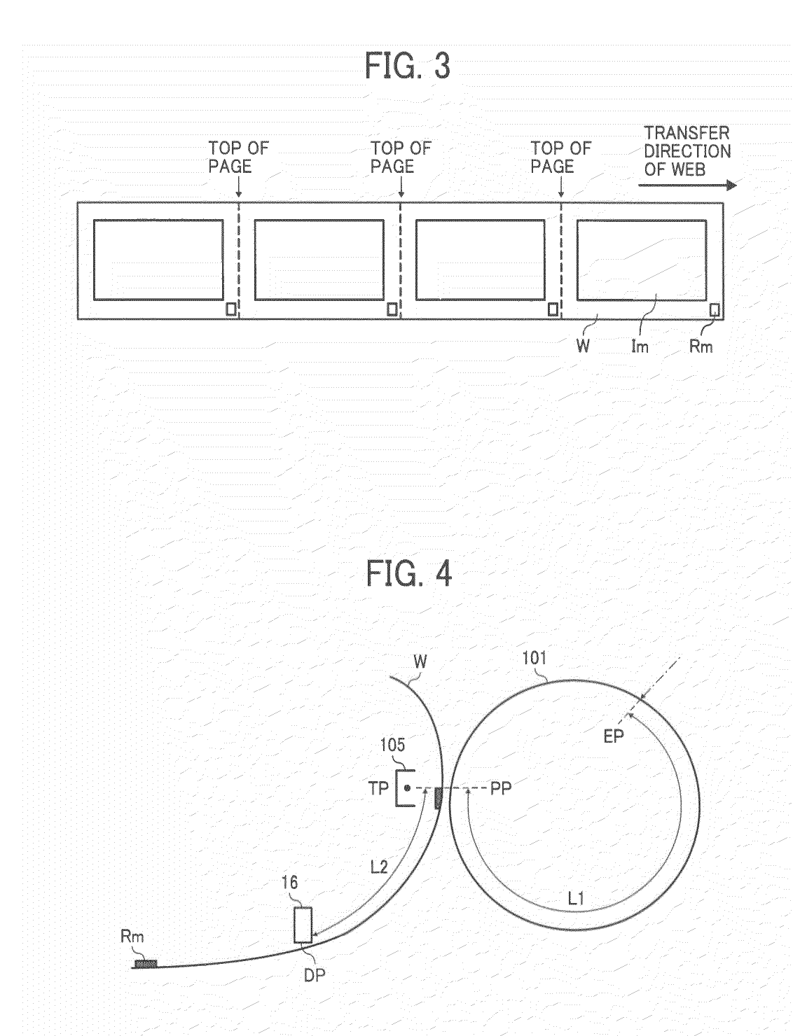

FIG. 3 is an example of the web W on which the alignment mark is formed by the first printing apparatus P1. An alignment mark (toner mark) Rm Is printed on the leading end of each page of the web W relative to the transfer direction together with an image Im formed based on printing data as illustrated in FIG. 3. The device that forms the image Im may also form the alignment mark or a device to form the alignment mark independently can be provided. In this embodiment, the device that forms the image Im also forms the alignment mark when the image Im is formed on the photoreceptor drum 101.

The web W discharged from the first printing apparatus P1 is sent into the second printing apparatus P2 after the side of the web W is reversed by the reversing device T. As a result of reversing the side of the web W by the reversing device T, the first side of the web W on which the toner mark Rm is held opposes the detection side of the mark sensor 16 and the second surface (blank surface) opposes the surface of the photoreceptor drum 101.

A latent electrostatic image corresponding to the toner mark Rm representing the leading end of the page is formed on the photoreceptor drum 101 by the light source 103 of the first printing apparatus P1 and then the controller 17 generates a web transfer control signal (CPF-N signal) in synchronization with the timing of forming the toner mark Rm. Similarly, the light source 103 of the second printing apparatus P2 starts irradiation independently from the first printing apparatus P1 and generates a web transfer signal (CPF-N) on this irradiation timing.

The web transfer control signal of P1 and the web transfer control signal of P2 are independently generated but the interval therebetween is the same. A detailed description of the controller 17 is omitted because forming synchronous pulses on generation of a laser beam is known. The web transfer control signal (CPF-N) generated by the controller 17 is transmitted to each of the first printing apparatus P1 and the second printing apparatus P2 and a motor control signal to control the transfer speed of the web W is generated based on the web transfer control signal.

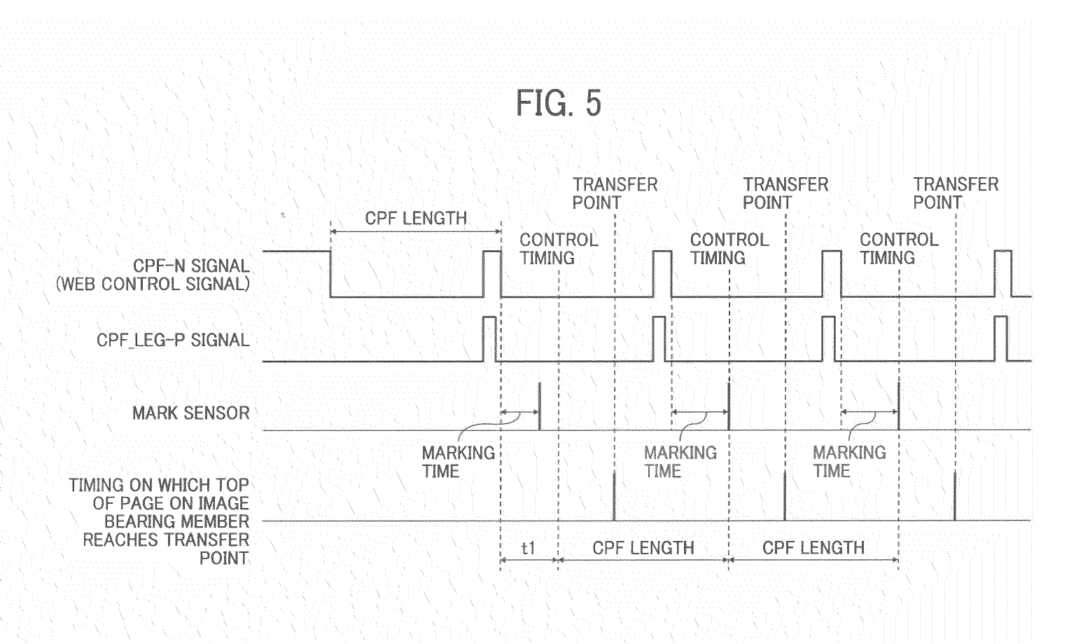

FIG. 4 is a diagram illustrating alignment control in the printing system of the present disclosure and FIG. 5 is a diagram illustrating the control signal and the timing of operation.

In FIG. 4, a position EP on the photoreceptor drum 101 is the irradiation point where a latent electrostatic image is formed. Every time a latent electrostatic image corresponding to the leading end of the page relative to the transfer direction thereof is faulted by a laser beam of the light source 103 (FIG. 1), the web transfer control signal (CPF-N) illustrated in FIG. 5 is formed.

In addition, since the photoreceptor drum 101 is normally controlled to rotate at a predetermined constant processing speed, the leading end of the page on the photoreceptor drum 101 reaches a transfer point TP per cycle of the web transfer control signal, i.e., CPF length illustrated in FIG. 5.

Therefore, the leading end of the page on the photoreceptor drum 101 and the leading of the web W can be matched highly precisely at the transfer point TP by controlling the web transfer speed in such a manner that the phase difference between the generation timing of the web transfer control signal (CPF-N) from the controller 17 and the detection timing of the toner mark Rm by the mark sensor 16 in the second printing apparatus P2 is constant.

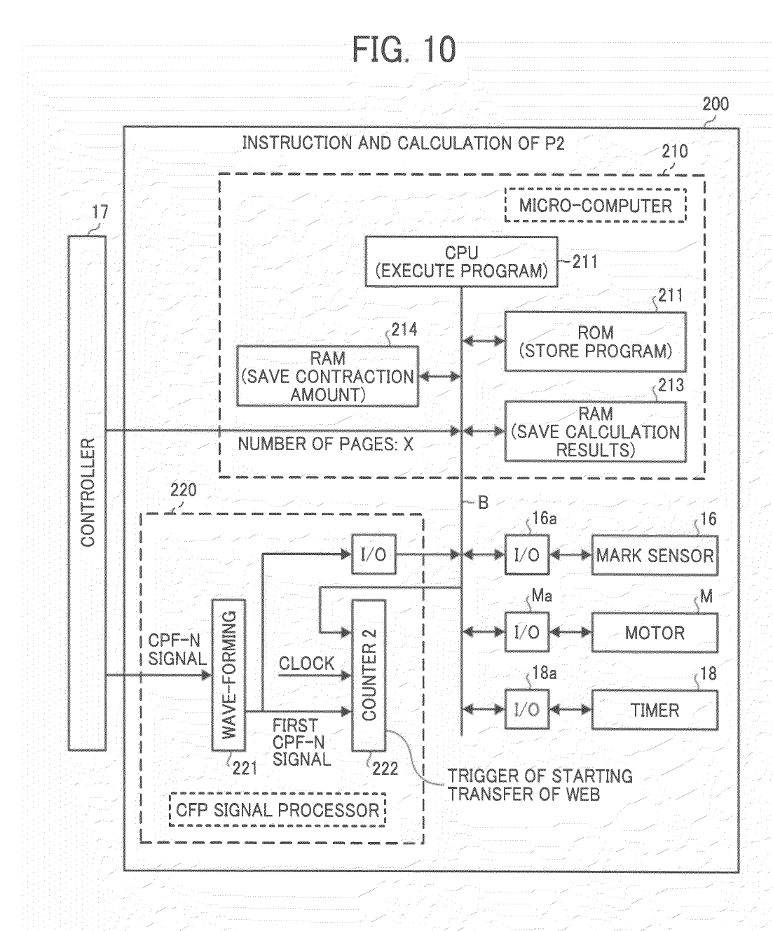

To control the web transfer as described above, the second printing apparatus P2 has a control device 200 as illustrated in FIG. 10.

As illustrated in FIG. 10, the control device 200 has a microcomputer 210 and a CPF signal processor 220. The microcomputer 210 and the CPF signal processor 220 are connected with each other via a bass B. The microcomputer 210 has a CPU 211 that provides instructions to the second the printing apparatus P2 and carries out required operations, a ROM 212 that stores various kinds of programs executed by the CPU 211, and a RAM 213 that temporarily stores operation results. In this embodiment, the microcomputer 210 controls the transfer of the web W and the rotation speed of the photoreceptor drum 101.

Therefore, the mark sensor 16 is connected with the microcomputer 210 via an I/O interface 16a and the bass B and in addition, the transfer rollers 8 and 9, the transfer belt 11, and respective motors M that drives the photoreceptor drum 101 are connected with the microcomputer 210 via an I/O interface Ma and the bass B. The controller 17 generates CPF-N signals corresponding to the printing data to be printed on the web W. The CPF signal processor 220 has a waveform forming circuit 221 and a counter 222. The waveform forming circuit 221 receives a CPF-N signal, forms the waveform of the input CPF-N signal, and outputs it to the counter 222. The counter 222 reacts upon the input of the CPF-N signal and starts counting by a clock provided from the outside.

In this embodiment, as illustrated in FIG. 4, the distance on the surface of the photoreceptor drum between the irradiation point EP and the transfer point TP by the transfer device 105 is represented by L1 and the distance on the web transfer path between the transfer point TP and the detection point DP by the mark sensor 16 is represented by L2. In addition, when the web is transferred under the condition that a leading end PP of the page virtually set on the photoreceptor drum 101 and the toner mark Rrn representing the leading end of the page of the web W match at the transfer point TP, the timing when the toner mark Rm is detected by the mark sensor Rm is determined as control timing. Making alignment represents controlling the detection timing of the toner mark Rrn by the mark sensor 16, i.e., the mark sensor signal illustrated in FIG. 5, to always match the control timing.

With regard to the printing images on the reverse side of the first page when printing starts, since an operator preliminarily loads the web W at the predetermined position of the second printing apparatus P2 before printing starts, the leading position of the page of the front side of the web W matches the leading position of the page of the reverse side. When forming the printing data of the first page on the photoreceptor drum 101 is finished, the printing apparatus receives a CPF-LEG-P signal for the first time from the controller 17 as illustrated in FIG. 5. When the CPF-LEG-P signal is received, the control timing is calculated.

The calculation of the control timing is executed based on, for example, the following idea: That is, to match the leading position of the second page virtually set on the photoreceptor drum 101 with the toner mark Rm representing the leading position of the second page of the web W at the transfer point TP, the toner mark Rm should be detected when the leading position of the second page on the photoreceptor drum 101 reaches the position with a distance of L2 away from the transfer point TP illustrated in FIG. 4.

Therefore, when the time between when the CPF-N signal is received for the second time and the control timing is represented by t1 and the processing speed of the printing apparatus is represented by Vp, t1 is represented by the following relationship.

t1=(L1−L2)/Vp Relationship 1

From the detection misalignment time of the toner mark Rm to the control timing, how much the leading position of the page to be printed on the reverse side is misaligned from the leading position of the page of the first (front) side is identified. When the he toner mark Rm is detected later than the control timing, the web transfer speed is increased. To the contrary, when the toner mark Rm is detected earlier than the control timing, the web transfer speed is reduced. That is, the web transfer speed is controlled to match the detection timing of the toner mark Rm with the control timing.

Furthermore, in addition to the control described above, the controller 200 may have a memory that stores the (marking) time between when the CPF-N signal is transmitted and when the toner mark Rm is detected every time the toner mark Rm is detected. When the toner mark Rm is detected, the difference At between the old data (marking time t0) that were stored in the memory when the toner mark was detected the last time and the new data (marking time t2) that are stored in the memory when the toner mark is detected this time is calculated by a computing device according to, for example, the following relationship 2.

Δt=t2−t0 Relationship 2

The controller 17 increases or decreases the web transfer speed with a ratio of Δt to the CPF length at the point of time. When VW represents the web transfer speed and the correction speed is represented by Δv1, Δv1 is obtained by using the following relationship 3.

Δv1=(Δt/CPF length)×VW Relationship 3

By adding Δv1 to the web transfer speed VW at the time of detection, the detection timing of the toner mark Rm matches the control timing.

By having the structure described above, the print position on the first side matches the print position of the second side even when the web W thermally contracted by normal fixing heat at the time of printing an image on the first side enters into the printing apparatus arranged at the back in series, thereby ameliorating the printing reliability for a web having no feed holes is improved.

However, in the printing system illustrated in FIG. 2, for example, when the printing operation is suspended due to trouble, etc., the web W is continuously heated during the suspension by the fixing preliminary heating plate 13a and the heating roll 13b of the printing apparatus illustrated in FIG. 1. In that case, the web W may be thermally-contracted and transformed more severely than the heat contraction caused in the normal fixing process.

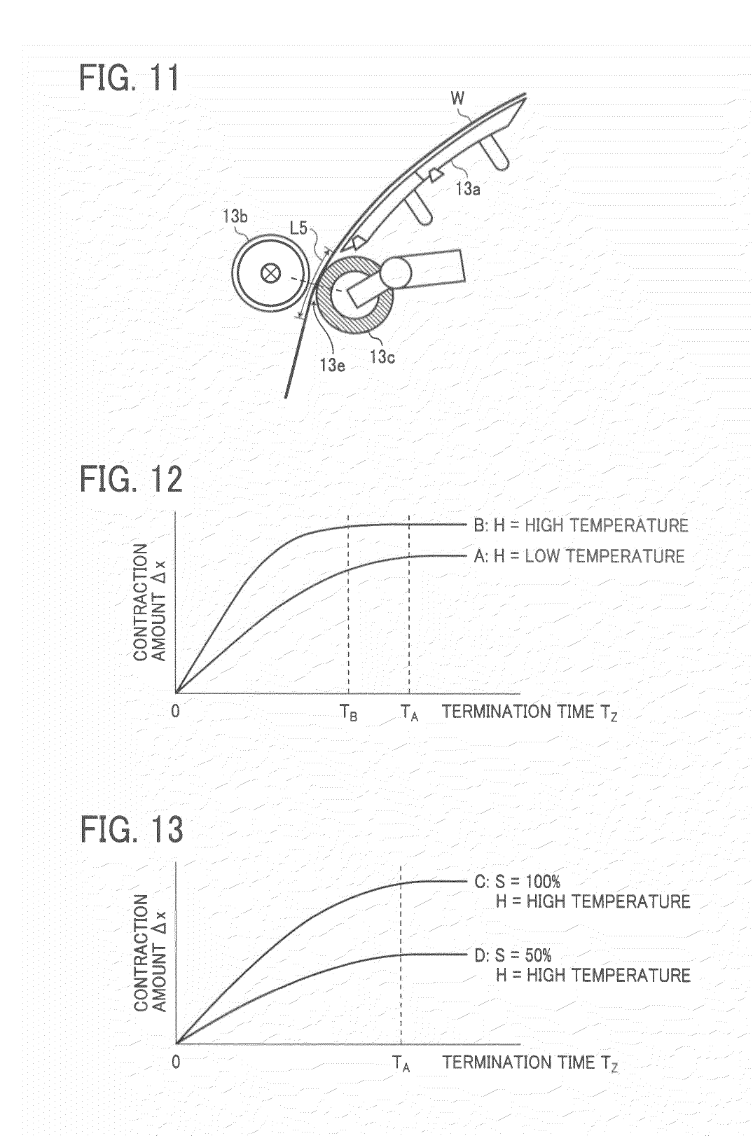

In particular, the heating roll 13b functioning as the final fixing device as illustrated in FIG. 11 has a heat source having a high temperature so that, for example, heat contraction at a certain portion (hereinafter referred to as L5) of the web W around the nipping point 13e is severer during the suspension than the other portions.

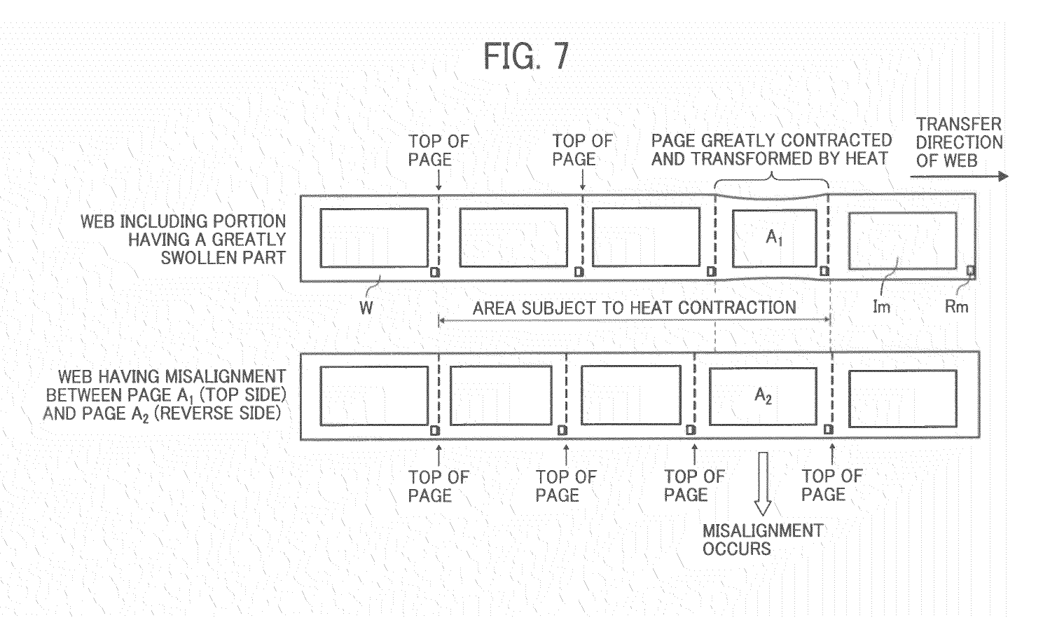

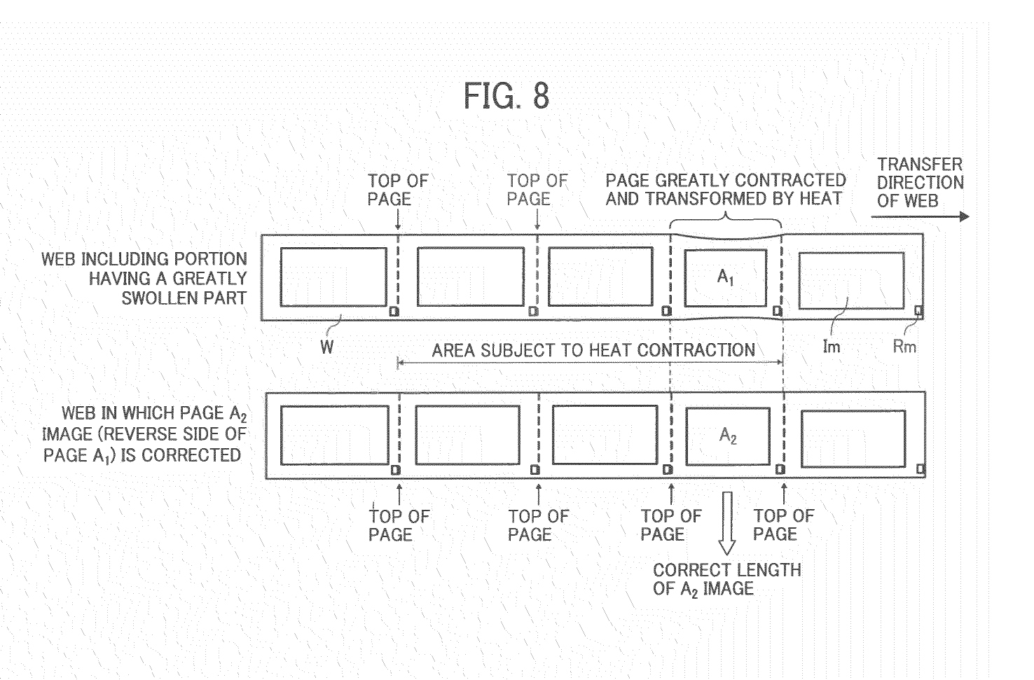

As illustrated in FIG. 7, if the page containing part or entire of L5 is represented by A₁ and printing operation resumes from this state, the page A₁ having a thermally contracted portion is discharged from the first printing apparatus P1, reversed by the reversing device, and fed into the second printing apparatus P2. The area subjected to heat contraction as illustrated in FIGS. 7 and 8 are resultantly formed by heating by a fixing preliminary heating plate and a heating roll. As a result, the alignment mark formed on the following page of the page A₁ having a thermally contracted portion is considerably earlier than that of the previous page.

Thus, to align the image position of the page A₂ which is the reverse side of the page A₁ illustrated in FIG. 7, the web transfer speed is required to be significantly reduced.

The RAM 214 stores the contraction amount in the leading unit of area (i.e., page) A₁ relative to the transfer direction among the area subjected to heat contraction as the contraction amount when heat contraction of the continuous recording medium roll by excessive heating occurs in the heat fixing device of the first printing apparatus. To solve the problem of the misalignment of the image positions of the page A₁ having an extremely thermally contracted portion as illustrated in FIG. 7 and its obverse page A₂, the printing system of the present disclosure has the controller 200 having a device that obtains the number of pages of the web W placed on the transfer path between the transfer position of the first printing apparatus P1 and the transfer position of the second printing apparatus P2 and a storage device (RAM 214 in FIG. 10) that stores the contraction amount generated when the web W is thermally contracted by excessive heating of the heat fixing device of the first printing apparatus P1 according to the condition defining the contraction amount. The controller 200 controls the alignment of the images formed on both sides of the web W according to the contraction amount.

That is, the length in the transfer direction of the image formed on the reverse page A₂ of the page A₁ is corrected based on the contraction amount of the page A₁ stored in the storage device (RAM 214).

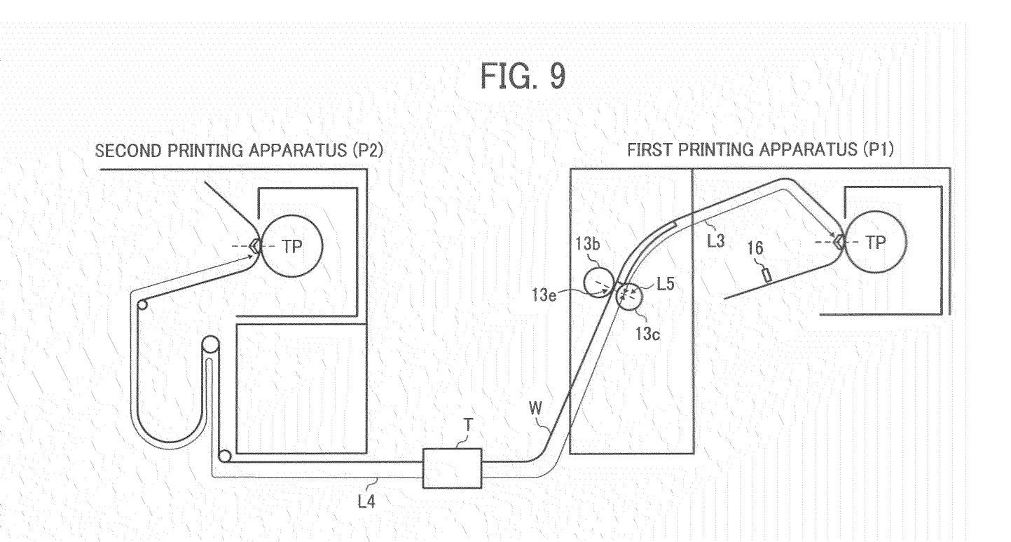

A method of determining the page A₁ having an extremely thermally contracted portion is described with reference to FIG. 9.

As illustrated in FIG. 9, when the length between the transfer point TP of the first printing apparatus P1 and the nipping point 13e of the heating roll 13b and the pressure roll 13c is represented by L3, the (CFP) length of a single page of the web W is represented by PL, the number of pages of the web W placed between the transfer point TP of the first printing apparatus P1 and the transfer point TP of the second printing apparatus P2 is represented by X, the number of pages Y while the page containing the nipping point 13e passes through the transfer point TP of the second printing apparatus P2 after printing starts is represented by the following relationship 4.

Y=X−(L3/PL) Relationship 4

That is, the Yth page after printing starts is stored in the memory as the page A₁ having an extremely thermally contracted portion which has the largest portion of L5.

When the toner image to be formed on the reverse page A₂ of the first page A₁ determined as the page having the largest heat contraction portion is formed on the photoreceptor drum 101, the toner image is shrunk in the transfer direction of the web W by reducing the rotation speed of the photoreceptor drum 101. Therefore, the image length in the web transfer direction of the reverse page A₂ matches the image length of the first page A₁ as illustrated in FIG. 8.

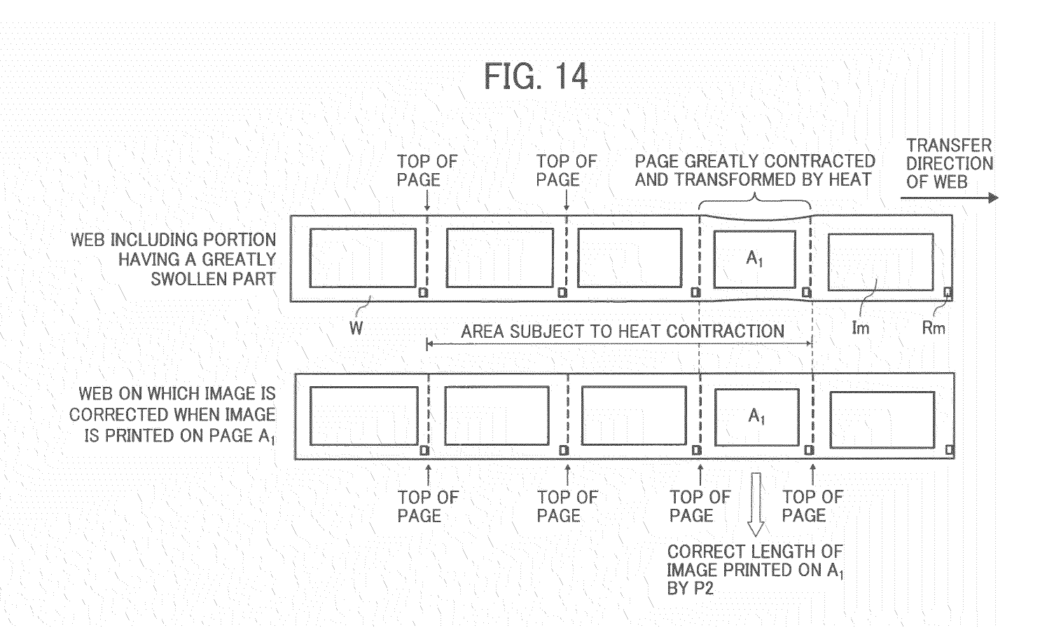

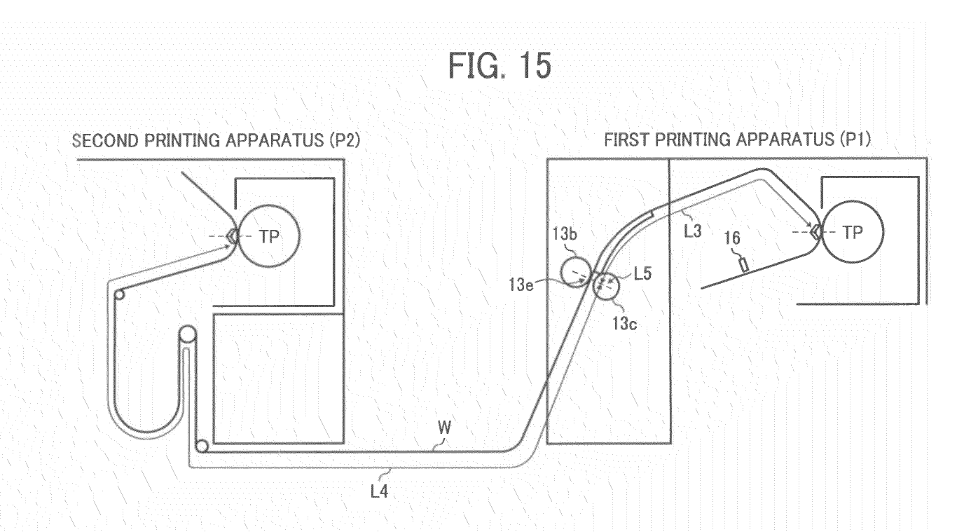

As illustrated in FIG. 15, in the case in which the reversing device T illustrated in FIG. 9 is removed and an image is printed on the identified first page A1 for the second time by P2, the image length of the page A1 printed by the second printing apparatus P2 can be aligned with the length of the image printed on the page A1 by the first printing apparatus P1 as illustrated in FIG. 14.

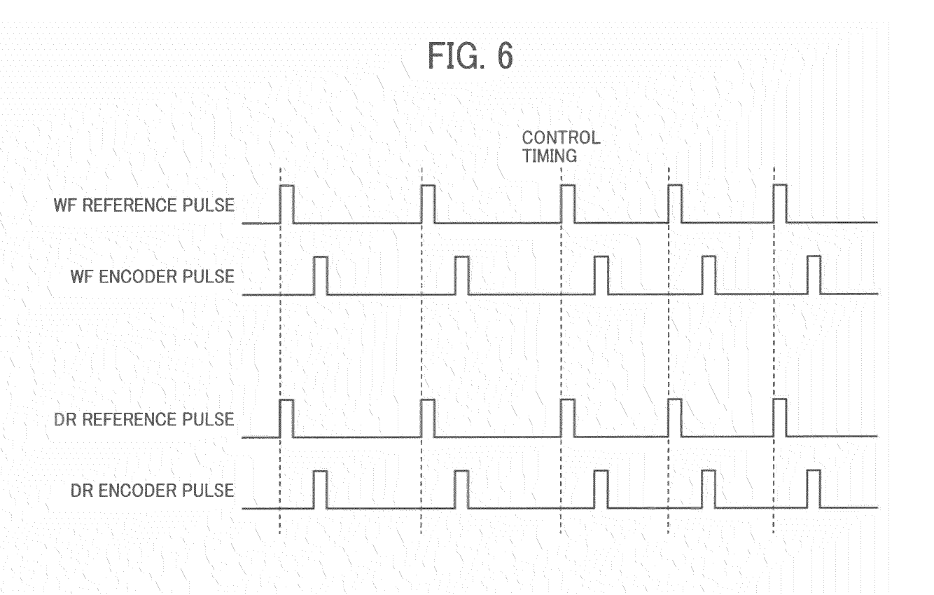

In addition, the rotation speed of the photoreceptor driving motor that drives the photoreceptor drum 101 is controlled by making encoder pulses (hereinafter referred to as DR encoder pulse) output from the photoreceptor driving motor follow the reference pulse (hereinafter referred to as DR reference pulse). Therefore, the rotation speed of the photoreceptor drum 101 can be changed by changing the frequency of the DR reference pulse. FIG. 6 is a timing chart illustrating synchronous control of the web transfer and the photoreceptor drum. WF reference pulse represents web transfer reference pulse.

In this embodiment, as illustrated in FIG. 7, the rotation speed of the photoreceptor drum is corrected per page because there is one alignment mark Rm on the leading position of the page. However, if there are multiple alignment marks on a single page, the rotation speed can be corrected by the gap therebetween.

Also the method of changing the DR reference pulse frequency of the photoreceptor drum 101 is described.

First, when the contraction amount of the page A₁ is represented by Δx, the rotation speed Vd of the photoreceptor drum 101 is reduced with a ratio of Δx to the page length PL. When the speed of the photoreceptor drum is represented by Vd and the correction speed is represented by ΔV2, ΔV2 is obtained by the following relationship 5.

ΔV2=(Δx/PL)×Vd Relationship 5

When a toner image for the Yth page after printing starts is foamed on the surface of the photoreceptor drum, the control of matching the detection timing of the alignment mark and the control timing and the control by the distance for detecting the alignment mark (normal alignment control) are suspended and the DR reference pulse is changed so that the rotation speed Vd of the photoreceptor drum 101 is corrected with Δv2 obtained by the relationship 5. Then, after the Yth page, the rotation speed is made back to the speed before correction for the normal alignment correction control described above.

The printing system of the present disclosure stores the contraction amount Δx when the web W is thermally contracted by excessive heating by the heat fixing device 13 of the first printing apparatus P1 according to the conditions defining the contraction amount Δx.

One of the conditions defining the contraction amount Δx is, for example, the retention time (hereinafter referred to as suspension time) of the web W due to transfer suspension thereof in the heat fixing device 13 of the first printing apparatus P1.

As illustrated in FIG. 12, as the suspension time Tz increases, the contraction amount Δx in the heat fixing device 13 of the first printing apparatus P1 increases. After a certain time T_{A}, the contraction amount remains the same without any further change.

The suspension time Tz is measured by a timer 18 connected via the I/O interface 18a illustrated in FIG. 10 and the bass B and stored in the RAM 213. The contraction amount Ax according to the suspension time Tz is preliminarily determined based on the experiment prediction. For example, the Table 1 shown below is stored as the contraction amount Δx according to the suspension time Tz.

TABLE 1

| Suspension Time T_{z} *1 | Contraction Amount ΔX *2 |
|---|---|
| T_{A} or more | ΔX₁ |
| T_{B} to T_{A} | ΔX₂ |
| T_{c} to T_{B} | ΔX₃ |
| T_{D} to T_{c} | ΔX₄ |
| 0 to T_{D} | ΔX₅ |

*1: TA > TB > TC > TD > 0
*2: ΔX₁ > ΔX₂ > ΔX₃ > ΔX₄ > ΔX₅

In Table 1, the contraction amount is represented by Δx₁ for the suspension time T_{A} or longer, the contraction amount is represented by Δx₂ for the suspension time from T_{B} to less than T_{A}. The contraction amount is represented by Δx₃ for the suspension time T_{C} to less than T_{B}. The contraction amount is represented by Δx₄ for the suspension time T_{D} to less than T_{C}. The contraction amount is represented by Δx₅ for the suspension time of zero to less than T_{D}. Each has the following relationship: T_{A}>T_{B}>T_{C}>T_{D}>0 and Δx₁>Δx₂>Δx₃>Δx₄>Δx₅.

In addition, another example of the conditions defining the contraction amount Δx is the preset temperature H of the heating roll 13b in the heat fixing device 13 of the first printing apparatus P1.

The preset temperature of the heating roller 13b has modes of a preset high temperature, a preset middle temperature, and a preset low temperature. These preset temperatures are changed depending on the kinds of web (e.g., thick paper, thin paper) and set by an operator via the controller 17.

As illustrated in FIG. 12, the contraction amount Δx is larger in the case B in which the preset temperature H of the heating roll is the preset high temperature B than in the case A in which the preset temperature H of the heating roll is the preset low temperature A. The time until the contraction amount having no further change is shorter in T_{B} in the preset high temperature B than in T_{A} in the preset low temperature A. Therefore, the contraction amount Δx for the preset temperatures can be determined correctly by preliminarily determining the contraction amount Δx depending on such temperature presets based on the experiment prediction and saving the Table 1 of the contraction amount Δx set for each preset temperature in RAM 213.

Furthermore, yet another example of the conditions defining the contraction amount Δx is the page length which is the length of the unit area of the web W heated in the heat fixing device 13 of the first printing apparatus P1.

If the page length is different, the ratio S of L5, which is a certain portion of the web W around the nipping point 13e is different so that the contraction amount Δx changes. The value of L5 is determined by, for example, the length of the diameter of the heating roll 13b or the gap between the heating roll 13b and the continuous recording medium roll during suspension. In addition, in the case of an ink jet system, for example, L5 can be determined by the portion in which a large amount of ink is attached because the heat contraction by drying is severe for a portion in which ink is attached in a large amount.

For example, when S is 50% illustrated as C in FIG. 13, the contraction amount Δx is smaller than when S is 100% illustrated as D in FIG. 13 for the same suspension time. The printing system of the present disclosure identifies the ratio of L5 occupying in the page A₁ as the condition defining the contraction amount Δx.

The ratio S (%) of L5 in the page A₁ is calculated by the following relationships 6 and 7 when the distance between the nipping point 13e of the first printing apparatus P1 and the transfer point TP of the second printing apparatus P2 is represented by L4.

When (L4+L5/2) % PL<L5/2 (where % represents a remainder of division), S satisfies the following relationship 6:

S=[L5−{(L4+L5/2) % PL}]/PL×100 Relationship 6

When (L4+L5/2) % PL>L5/2, S satisfies the following relationship 7:

S=(L5/2+L4 % PL)/PL×100 Relationship 7

The contraction amount Δx is corrected according to the ratio S obtained in the relationship 6 or relationship 7.

Correction can be made by, for example, using a corresponding coefficient from the following Table 2 for coefficient K corresponding to the ratio S of L5 in the page A₁.

TABLE 2

| Ratio of L5 in A1 (%) | Coefficient K |
|---|---|
| 100 to * | 1 |
| 90 to 99 | 0.9 |
| 80 to 89 | 0.8 |
| 70 to 79 | 0.7 |
| 60 to 69 | 0.6 |
| 50 to 59 | 0.5 |
| 40 to 49 | 0.4 |
| 30 to 39 | 0.3 |
| 20 to 29 | 0.2 |
| 0 to 19 | 0.1 |

* More than 100% is possible in Relationships 6 and 7

The coefficient K shown in Table 2 is 1 when the ratio S of L5 in the page A₁ is 100%.

S may surpass 100% from the relationships 6 and 7.

A corrected contraction amount Δxs is calculated by the following relationship 8:

Δxs=K×Δx Relationship 8

As described above, the contraction amount Δxs of the page A₁ can be obtained by the ratio of L5 occupying in the page A₁ obtained from the suspension time Tz by each preset temperature H and the page length. The contraction amount Δxs is assigned into the relationship 5 to calculate the correction speed of the photoreceptor drum 101.

By changing the rotation speed of the photoreceptor drum by the calculated correction speed, the position of the image of the page A₁ and the position of the image formed on the reverse page A₂ are matched precisely.

Thus, for the page having an extremely thermally contracted and transformed portion around the heat fixing portion of the heat fixing device 13 of the first printing apparatus P1 during suspension of printing, the image position of the reverse side of the page is aligned.

In this embodiment, the structure to which an image forming apparatus employing electrophotography is applied is described but a printing device employing, for example, an ink jet system can be used to print images on the web W. In such an ink jet system, images are directly depicted in the scanning direction of the web based on the printing data. Thus, if a system is configured to have a printing apparatus employing ink jet system as the second printing apparatus P2, printing by the second printing apparatus P2 can be aligned with the printing by the first printing apparatus P1. In the case of ink jet printing, the web is normally heated by accelerating the drying of ink on the web. Therefore, if this heating of the web is performed on the upstream side of the mark sensor 16 in the web transfer path in the second printing apparatus P2, printing made by the second printing apparatus P2 can be precisely aligned with the printing by the first printing apparatus P1 for the web contracted intolerably by applying the same printing control as the present disclosure.

This document claims priority and contains subject matter related to Japanese Patent Applications nos. 2010-167176 and 2011-142854, filed on Jul. 26, 2010 and Jun. 28, 2011, the entire contents of which are hereby incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A printing system comprising:
a first printing apparatus to form an image on a first side of a continuous recording medium roll having sectionable pages of predetermined length in a direction of conveyance of the recording medium and no feed holes therein, the first printing apparatus comprising a heat fixing device comprising a heating roll and a device to form an alignment mark on the pages;
a second printing apparatus provided downstream from the first printing apparatus to form an image on a second side of the recording medium roll, the second printing apparatus comprising a detector to detect the alignment mark and a control device to measure one of a gap between the alignment marks detected by the detector and a detection timing and control a conveyance speed of the recording medium roll according to measurement results, the control device comprising a device that identifies the number of pages of the recording medium placed on a transfer path between the first printing apparatus and the second printing apparatus and a storage device to store a value representing a contraction amount by which the recording medium is thermally contracted by excessive heating by the heat fixing device of the first printing apparatus correlated with a condition defining the contraction amount, and aligns positions of images formed on both sides of the recording medium according to the contraction amount; and
a controller comprising a CPU and associated memory devices to control conveyance of the recording medium.

2. The printing system according to claim 1, wherein the storage device of the control device of the second printing apparatus stores a value representing a contraction amount of a leading page relative to the conveyance direction of the recording medium.

3. The printing system according to claim 1, wherein the condition defining the contraction amount is a retention time of the recording medium in the heat fixing device of the first printing apparatus due to suspension of conveyance thereof.

4. The printing system according to claim 1, wherein the condition defining the contraction amount is a preset temperature of the heating roll of the heat fixing device of the first printing apparatus.

5. The printing system according to claim 1, wherein the condition defining the contraction amount is a length of the sectionable pages of the recording medium heated by the heat fixing device of the first printing apparatus.
